(19) United States
(12) Patent Application Publication
(10) Pub. No.: US 2026/0099048 A1
(43) Pub. Date: Apr. 9, 2026

(54) APPARATUS AND METHOD FOR A HEAD-UP DISPLAY

(71) Applicant: Harman International Industries, Incorporated, Stamford, CT (US)

(72) Inventors: Junghoon SEO, Seoul (KR); Chulmin LEE, Hwaseong-si (KR); Haewon YOU, Suwon (KR)

(73) Assignee: Harman International Industries, Incorporated, Stamford, CT (US)

(21) Appl. No.: 19/488,436

(22) Filed: Nov. 26, 2025

Related U.S. Application Data
(63) Continuation of application No. PCT/US2023/067913, filed on Jun. 5, 2023.

(51) Int. Cl. G02B 27/01; G06F 3/01

(52) U.S. Cl. CPC G02B 27/0149; G06F 3/013; G02B 2027/0154

(57) ABSTRACT

A method includes receiving a user input by a video display controller, determining a position of a perceived region based on the user input, determined a variance of at least one or more lines outside an eyebox of a user based on the position of the perceived region, calculating a corresponding position of a mirror based on the variance of the one or more lines being outside of the eyebox, and causing the perceived region to appear within the eyebox of the user based on the corresponding position of the mirror and the determined variance of the one or more lines.

### CROSS-REFERENCE TO RELATED APPLICATIONS

This application is a continuation of International Application No. PCT/US2023/067913, filed on June 5, 2023. The disclosures of the above applications are incorporated herein by reference.

### FIELD

The present disclosure relates to a heads-up display (HUD), and more particularly, to systems and methods for controlling the HUD utilizing motor driving and video timing control.

### BACKGROUND

The statements in this section merely provide background information related to the present disclosure and may not constitute prior art.

A heads-up display (HUD) generally provides information on a windshield of a vehicle that can be viewed by a driver of the vehicle while operating the vehicle. A position of the HUD, such as the height of the displayed information, is typically adjusted by tilting an axis of a mirror. The tilt of the axis of the mirror is usually driven by a motor. Inaccuracies arise in this typical adjustment of the HUD because the motor is incapable of fine tuning the height of the HUD due to a minimum angle of change of the mirror. That is, the minimum angle of change of the mirror does not functionally allow for the more precise movements of the mirror. Additionally, the constant driving of the motor can result in longevity issues of the motor components.

### SUMMARY

This section provides a general summary of the disclosure and is not a comprehensive disclosure of its full scope or all of its features.

The present disclosure provides a method for receiving a user input by a video display controller. A position of a perceived region is determined based on the user input. Whether a variance of at least one or more lines is outside an eyebox of a user is determined based on the position of the perceived region. A corresponding position of a mirror is calculated based on the variance of the at least one or more lines being outside the eyebox of the user. The perceived region is caused to appear within the eyebox of the user based on the corresponding position of the mirror and the determined variance of the at least one or more lines.

In variations of the method of the above paragraph, the method includes the user input comprising at least one of a content of the perceived region, a height of the perceived region, or a format of the perceived region. Another variation of the method of the above paragraph, the method includes a display region that further includes the perceived region, wherein the perceived region is varied based on a video control timer. Furthermore, a variation of the method of the above paragraph, the method includes adjusting the corresponding position of the mirror using a motor and adjusting the perceived region within the display region using a video timing control. Additionally, a variation of the method of the above paragraph, the method includes controlling a motor to drive a tilt of the mirror to thereby change a tilt position of the mirror. In yet another variation of the method of the above paragraph, the method includes the tilt of the mirror is based on at least one preset positional interval corresponding to a foundational position. An additional variation of the method of the above paragraph, the method includes the position of the perceived region is adjusted based on the eyebox of the user.

The present disclosure provides an apparatus comprising a display, a first mirror, a second mirror, a motor, and a video display controller, wherein the video controller is configured to receive a user input; determine, based on the user preference, a position of a perceived region; determine, based on the position of the perceived region, a variance of at least one or more lines is outside an eyebox of a user; calculate, based on the variance of the least one or more lines being outside the eyebox of the user, an axis of tilt of the mirror; and cause, based on the corresponding position of the mirror and the determined variance of the at least one or more lines, the perceived region to appear within the eyebox of the user.

The present disclosure provides an apparatus of the above paragraph, which may be implemented individually or in any combination, the apparatus includes the user preference comprising at least one of a content of the perceived region, a height of the perceived region, or a format of the perceived region. Another variation of the apparatus of the above paragraph, which may be implemented individually or in any combination, the apparatus including a display region that further includes the perceived region, wherein the perceived region is varied based on a video control timer. Furthermore, another variation of the apparatus of the above paragraph, which may be implemented individually or in any combination, the apparatus including adjusting the corresponding position of the mirror using a motor and adjusting the perceived region within the display region using a video timing control. Additionally, a variation of the apparatus of the above paragraph, which may be implemented individually or in any combination, the apparatus including causing the perceived region to appear within the eyebox of the user comprises controlling a motor to drive a tilt of the mirror to thereby change a tilt position of the mirror. In yet another variation of the apparatus of the above paragraph, which may be implemented individually or in any combination, the apparatus including the tilt of the mirror is based on at least one preset positional interval corresponding to a foundational position. An additional variation of the apparatus of the above paragraph, which may be implemented individually or in any combination, the apparatus including the position of the perceived region is adjusted based on the eyebox of the user.

The present disclosure provides one or more non-transitory computer-readable media storing processor-executable instructions that, when executed by at least one processor, cause the at least one processor to receive a user input; determine, based on the user preference, a position of a perceived region; determine, based on the position of the perceived region, a variance of at least one or more lines is outside an eyebox of a user; calculate, based on the variance of the least one or more lines being outside the eyebox of the user, an axis of tilt of the mirror; and cause, based on the corresponding position of the mirror and the determined variance of the at least one or more lines, the perceived region to appear within the eyebox of the user.

In variations of the one or more non-transitory computer-readable media, which may be implemented individually or in any combination, the computer-readable media including the user preference comprises at least one of: a content of the perceived region, a height of the perceived region, or a format of the perceived region. Another variation of the one or more non-transitory computer-readable media, which may be implemented individually or in any combination, the computer-readable media including a display region including the perceived region, wherein the perceived region is varied based on a video control timer. Furthermore, another variation of the one or more non-transitory computer-readable media, which may be implemented individually or in any combination, the computer-readable media including causing the perceived region to appear within the eyebox of the user comprises controlling a motor to drive a tilt of the mirror to thereby change a tilt position of the mirror. Additionally, another variation of the one or more non-transitory computer-readable media, which may be implemented individually or in any combination, the computer-readable media including the tilt of the mirror is based on at least one preset positional interval corresponding to a foundational position. In yet another variation of the one or more non-transitory computer-readable media, which may be implemented individually or in any combination, the computer-readable media including the position of the perceived region is adjusted based on the eyebox of the user.

Provided are systems and methods for controlling a heads-up display utilizing motor driving and video timing control. In one aspect, a user preference is received by a video display controller. A position of a perceived region (e.g., a projected image) is determined based on the user preference. A variance of whether at least one more lines is outside an eyebox of a user is determined based on the position of the perceived region. An axis of tilt of a mirror is then determined based on the variance of the at least one or more lines being outside the eyebox of the user. The perceived region is then caused to appear within the eyebox of the user based on the axis of tilt of the mirror and the variance of the at least one or more lines.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic diagram illustrating a heads-up display, configured to adjust a display level of HUD information in accordance with one or more embodiments;

FIG. 2 depicts a diagram illustrating multiple positions or steps in a display region in accordance with one or more embodiments;

FIG. 3 depicts an example representation of a display region in accordance with one or more embodiments;

FIG. 4 is a timing diagram illustrating the timing of signals related to the position of HUD information in accordance with one or more embodiments;

FIG. 5 is a flowchart illustrating an example of controlling a HUD using motor and video controls in accordance with one or more embodiments; and

FIG. 6 is a flowchart illustrating an example method of controlling a HUD in accordance with one or more embodiments.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure provides systems and methods for controlling a heads-up display (HUD) utilizing motor driving and video timing control. The systems include the activation of a motor to drive the tilt of a mirror in combination with the activation of the video timing control to reposition a display region. For example, the motor driving and video timing control (e.g., control of data enable (DE) timing and display position) operate collaboratively to reposition the display region so that the display region is positioned within an optical path that originates from an eyebox of a user and represents at least a portion of a viewable range of the user with reduced motor motion. As such, in various implementations, the accumulation of backlash errors is reduced and/or the useful life of the motor is extended. Additionally, and as described below in further detail, the systems and methods disclosed herein provide for increased accuracy of the positioning of the display region in addition to the durability of the motor and mechanical components that drive the tilt of the mirror. For example, the DE timing is the time (e.g., duration) at which an image is displayed.

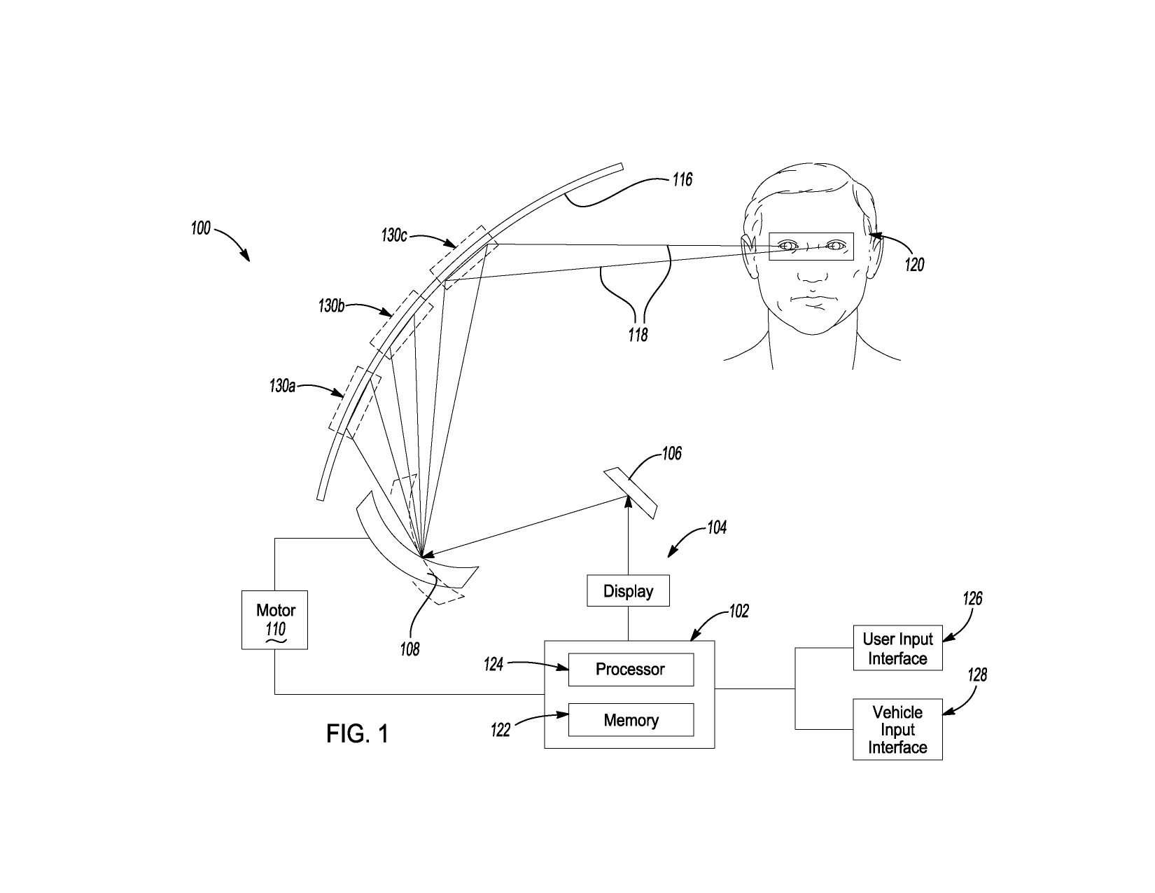

Referring to FIG. 1, a HUD control arrangement 100 is shown and generally includes a video display controller 102, a display 104, a first mirror 106, a second mirror 108, and a motor 110. In some examples, the structure 100 is implemented within a vehicle to adjust a display level of HUD information projected onto a windshield 116. It should be understood, however, that the structure 100 may be implemented within any general structure wherein HUD information may be displayed, such as a helmet or glasses and is not limited to the examples described herein.

In one or more examples, the first mirror 106 is a fold mirror, which can be planar or aspherical and reflects received light toward the second mirror 108. As another example, the second mirror 108 is a tiltable mirror, which can be aspherical and direct light toward the windshield 116. The direction of the light directed from the second mirror 108 is controlled to be within an optical path 118 that originates from an eyebox 120 of a user and represents at least a portion of a viewable range of the user in various examples. It is understood that the optical path 118 may vary based on the height of the eyebox 120 of the user. It is further understood that the height of the eyebox 120 may be based on the height of the user.

In one or more embodiments, the video display controller 102 includes a memory 122 and a processor 124, wherein the processor 124 is configured to execute instructions stored in the memory 122 to control the motor 110 and/or the output of the display 104. It is understood that the display 104 outputs an image or other data and/or a light to be reflected against the first mirror 106. The video display controller 102 may control the display 104 to project particular images and/or light based on the instructions stored in the memory 122 and/or based on other inputs from a user. For example, the user input interface 126 and a vehicle input interface 128 may be used to provide instructions to the video display controller 102 to control the display 104 based on user input and vehicle data/status, respectively. For example, user input to change a type of information displayed (e.g., to select between instrument data such as speed/RPM/etc. and navigation data such as turn directions), to select options when a graphical user interface is displayed, and/or to otherwise indicate user preferences are provided to the video display controller 102 and processed to alter a content, height, and/or format of the displayed data. It is understood that the user input interface 126, in some examples, receives user input from any suitable user input device, including but not limited to a touch screen, vehicle-mounted actuators (e.g., buttons, switches, knobs, dials, etc.), a microphone (e.g., for voice commands), an external device (e.g., a mobile device of a vehicle occupant), and/or other user input devices.

The vehicle input interface 128 receives data from vehicle sensors (not shown) and/or systems indicating a vehicle status and/or other vehicle data, which may be sent to the video display controller 102 to adjust content and/or format of the displayed data. For example, a current speed may be supplied (e.g., via a controller-area network, CAN, bus of the vehicle) to the vehicle input interface 128 and sent to the video display controller 102 to update the display of a current speed of the vehicle. The vehicle input interface 128 may also receive input from a navigation module (not shown) of the vehicle and/or other information sources within the vehicle.

In one or more embodiments, the video display controller 102 is also configured to activate the second mirror 110 via the motor 110. For example, the video display controller 102 sends instructions to the motor 110 to drive a tilt of the second mirror 108 to a specific angle or degree. For example, it is understood that the mirror 108 is tilted to a degree of +/-1. However, it is understood that the mirror 108 may be tilted to any degree. It is understood that the tilt of the second mirror 108 is based on an input of a user via the user input interface 126. In some examples, the motor 110 is a brushless DC electric motor. The motor 110 drives the tilt of the second mirror 108 to multiple positions, for example, at least three positions so that the direction of light may change so that a display region (130a, 130b, 130c) may be displayed to the user at different levels or heights. As another example, the motor 110 drives the tilt of the second mirror 108 based on the height of the eyebox 120 of the user. As a further example, the motor 110 drives the tilt of the second mirror 108 based on the user preferences provided via the user input interface 126.

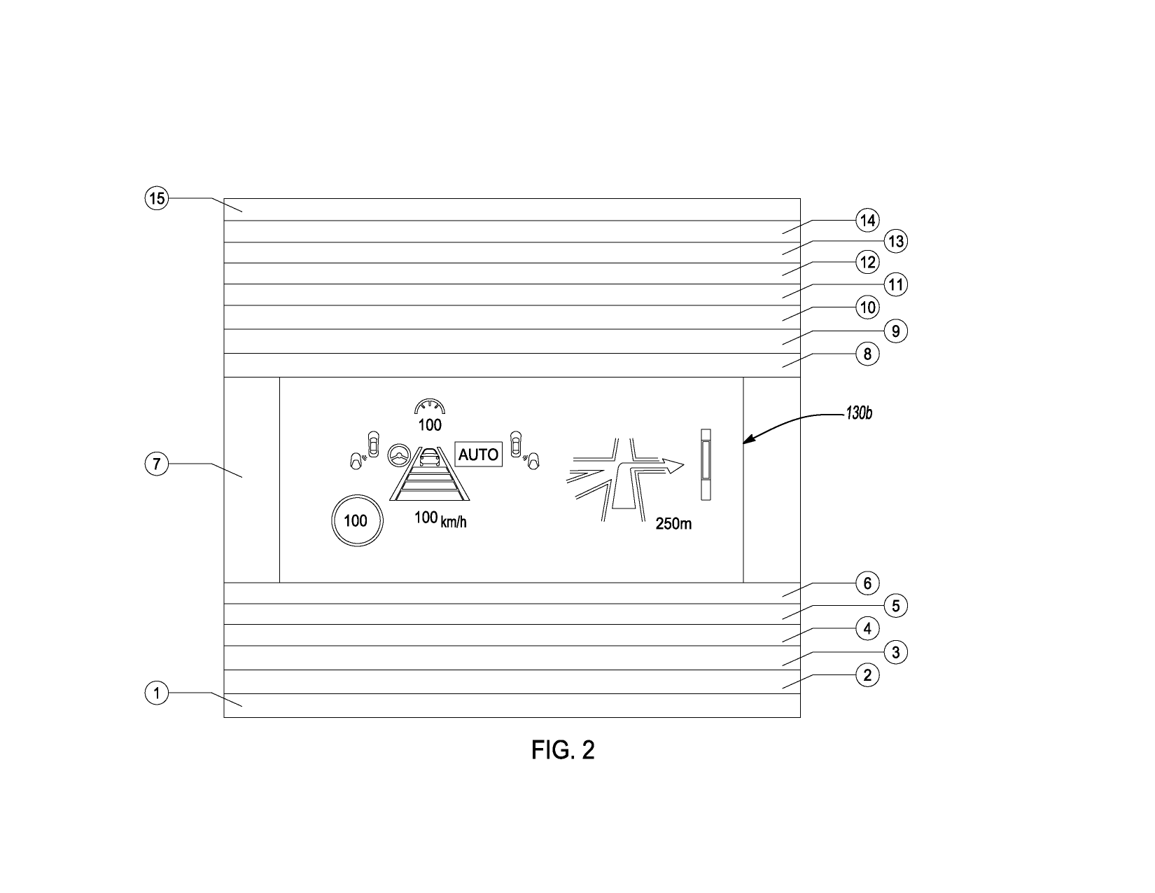

The display region 130b is further depicted with reference to FIG. 2, wherein display positions or steps are illustrated. In one or more embodiments, multiple positions are labeled 1-15. That is, in this example, fifteen discrete incremental display positions are provided. However, it is understood that any number of positions may be included that can be discrete or continuous. In some examples, position 1 corresponds to the display region 130a of FIG. 1, position 7 corresponds to the display region 130b of FIG. 1, and position 15 corresponds to the display region 130c of FIG. 1.

In one or more embodiments, the motor 110 drives the tilt of the second mirror 108 so that the display region 130 is displayed to the user at any of the foundational or base positions 1, 7, and 15 (e.g., motor defined positions). The display region 130 is also capable of being controlled to display the display region 130 in any of the intermediate positions 2-6 and 8-14 (using image processing or image timing control as described in more detail herein) based on a variance of at least one line of a plurality of lines (not shown) using one or more video timing controls as described in more detail herein. It is understood that the display region 130 is also capable of being controlled to display the display region 130 in any of the intermediate positions 2-6 and 8-14 based on a variance of at least one pixel of a plurality of pixels as well. For example, any of the intermediate positions 2-6 and 8-14 are achieved by adjusting or offsetting the position of the display region 130 from any of the foundational positions 1, 7, or 15 using video control (instead of mechanical control). It is understood that there may be any number of foundational positions and/or intermediate positions.

For example, in the case wherein the user requests the display region 130 to be positioned at intermediate position 11, and the display region 130 was initially positioned at foundational position 1, the motor 110 is controlled to drive the tilt of the second mirror 108 to foundational position 7. The position of the display region 130 is then controlled to provide an offset from foundational position 7, via the video timing control, so that the at least one line of the plurality of lines is varied so that the display region 130 is positioned at intermediate position 11. For example, the video timing control can activate a number of lines within the plurality of lines to vary a portion of the display region 130 that the user will see. It is understood that the repositioning or adjusting of the display region 130 from foundational position 1 to intermediate position 11 uses a collaborative or cooperative movement from the motor 110 and the video timing control (which can be performed simultaneously, concurrently, or sequentially). It is understood that the variance of the display region 130, via the utilization of the video timing control, reduces the movement of the motor 110 (e.g., travel distance) and the tilt of the second mirror 108, which enhances the accuracy of the positioning of the display region 130 and the durability of the motor 110 and any mechanical components that drive the tilt of the second mirror 108 in various examples.

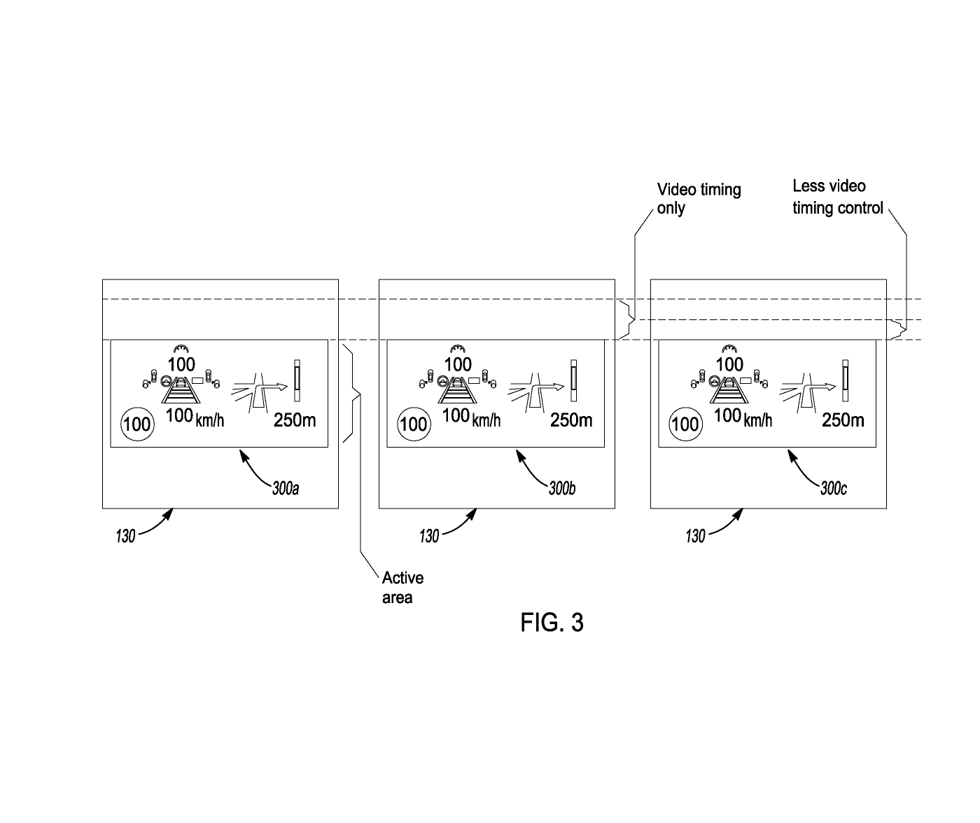

Referring to FIG. 3, the display region 130 is depicted as illustrating the variance or adjustment of the at least one line of the plurality of lines. For example, the video timing control can activate a number of lines within the plurality of lines to vary a portion of the display region 130 that the user will see. It is understood that the display region 130 includes the plurality of lines. For example, the display region 130 is fixed within a particular position corresponding to the angle of tilt at which the second mirror 108 is positioned in. For example, the display region 130 is only able to be repositioned by the tilt of the second mirror 108. In one or more embodiments, the video display controller 102 processes instructions stored in the memory 112 to vary the lines of the plurality of lines (e.g., activating a particular set of lines of the plurality of lines within the display region 130). It is understood that the instructions may be based on the user input received by the user input interface 126. It is further understood that, in the instance wherein the lines that are active are varied, the position of the projected image is changed. In one or more embodiments, the position of the projected image is changed through the video timing control and may be limited to specific locations. For example, the projected image may be limited to intermediate positions 2-6 or 8-14 illustrated in FIG. 2. However, the projected image may be controlled to be displayed to any number of intermediate positions.

In one or more embodiments, a perceived region 300a (e.g., the location in the display region 130 where the projected image is displayed) corresponds to the foundational position 1, 7, or 15, and is non-varied (e.g., the image has not been offset from the display region 130). In one or more embodiments, a perceived region 300b is shown as a maximum offset of the lines of the plurality of lines from the foundational position 1, 7, or 15. For example, in the case wherein the perceived region 300a correlates to the foundational position 1, the perceived region 300b may correlate to the intermediate position 6. For example, if the perceived region 300b is requested to be offset from the foundational position 1 any further (e.g., position 7), then driving of the motor 110 would be required. In one or more embodiments, a perceived region 300c (e.g., the projected image) is shown as a minimal offset of the lines of the plurality of lines from the foundational position 1, 7, or 15. For example, in the case wherein the perceived region 300a corresponds to the foundational position 1, the perceived region 300c corresponds to the intermediate position 3. It is understood that at each of the foundational positions 1, 7, and 15, the video timing control is reset. For example, each of the foundational positions 1, 7, and 15 represent eyeboxes at which point the video timing of the eyebox in which the image is displayed is initialized and a physical motor is driven. As another example, when the eyebox position corresponds to the intermediate position number 6, the user may first change the eyebox to the foundational position number 7. In this case, the physical motor causes the eyebox to move to the foundational position number 7 and the video timing is initialized so that the eyebox can be positioned to the intermediate position number 6 via activation of the at least one line of the plurality of lines within the display region 130. As another example, video timing may be the same upon its initialization at foundational position number 1, 7, and 15.

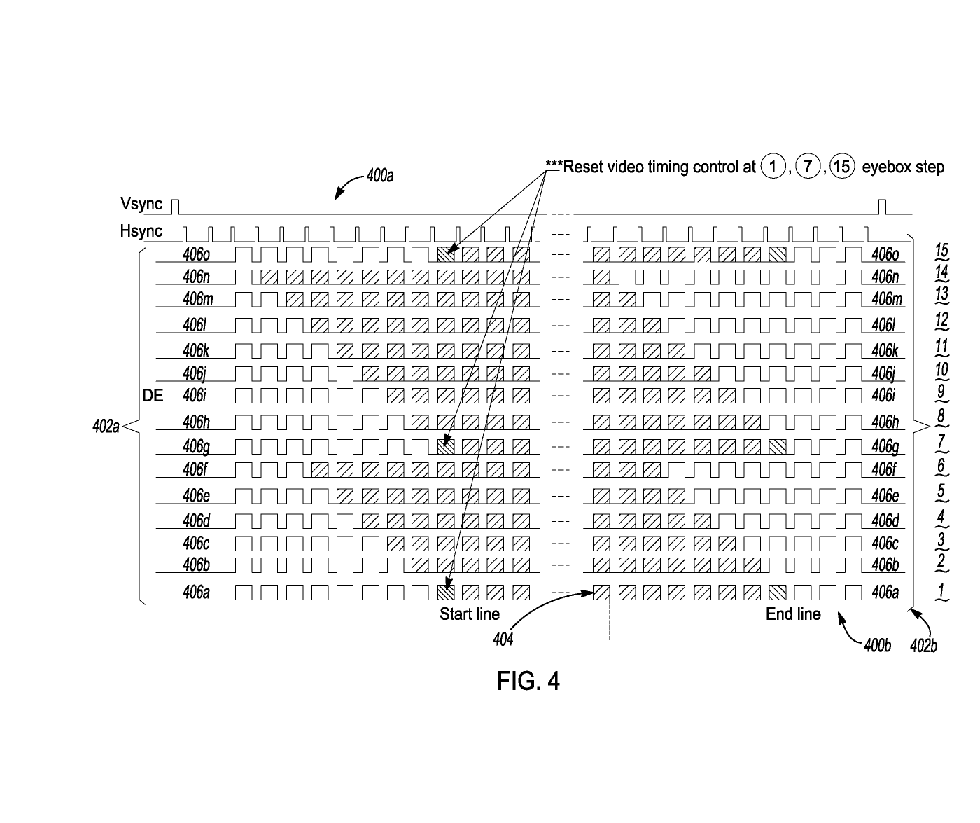

FIG. 4 shows a timing diagram 400 illustrating a time relationship of a plurality of control signals relative to the offset of the perceived region 300 from the display region 130. A first portion of the timing diagram 400a illustrates the time relationship of control signals 402a before any offset of the lines of the plurality of lines has occurred. In some examples, the control signals 402a are prompted by a user input, via the user input interface 126. In other examples, the control signals 402a are prompted by instructions stored within the memory 122 of the video display controller 102. It is further understood that the control signals may be prompted by instructions received from the vehicle input interface 128.

For example, a rising edge 404 of a plurality of rising edges of a timing signal 406 (e.g., 406a-406o) indicates the activation of the at least one line of the plurality of lines within the display region 130. Hsync is representative of a first line. The horizontal direction of the timing signal 406 represents a pixel. The vertical direction of the timing signal 406 represents a line. For example, the line is repositioned based on a single eyebox position. However, the repositioning of the line is not limited to a single eyebox position and may be repositioned based on multiple eyebox positions.

A second portion of the timing diagram 400b illustrates that a time relationship of a plurality of control signals 402b after the offset of the lines of the plurality of lines has occurred. For example, each of the control signals 402b of the plurality of control signals correspond to a position 1-15. It is understood, however, that any number of control signals may correspond to any position.

In one or more embodiments, the highlighted areas under the rising edges of each of the time signals (i.e., 406) illustrate the positioning of the display region 130. For example, correspondent to the offset of the perceived region 300 from the display region 130 positioned in the foundational position 1, 7, or 15, the highlighted areas under the rising edges of the time signals may vary. For example, the variance of the highlighted areas under the rising edges of the time signals (i.e., 406) indicate at which intermediate position 2-6, or 8-14 the perceived region 300 is positioned in.

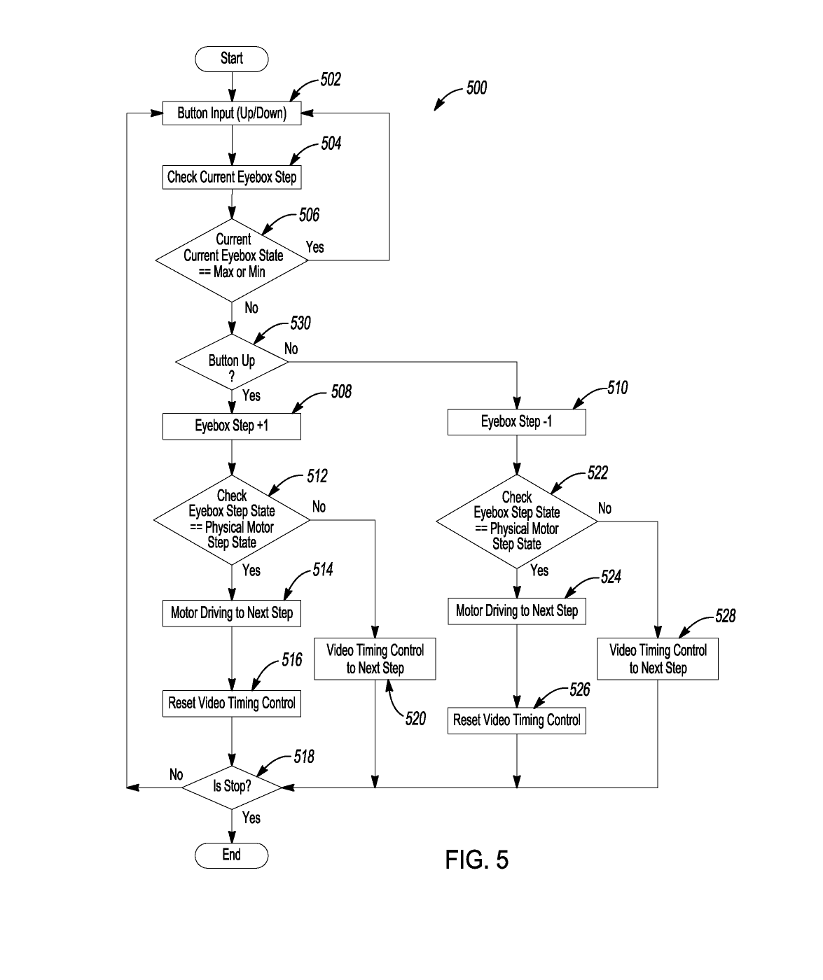

In one or more embodiments and referring to FIGS. 1 and 5, the user initiates a process 500 by inputting a command via the user input interface 126, at step 502. For example, the user input interface 126 receives user input (e.g., the command) from any suitable user input device, including but not limited to a touch screen, vehicle-mounted actuators (e.g., buttons, switches, knobs, dials, etc.), a microphone (e.g., for voice commands), an external device (e.g., a mobile device of a vehicle occupant), and/or other user input devices. Based upon the current location of the perceived region 300 relative to the optical path 118, a height of the eyebox 120 that represents at least the portion of the viewable range of the user is determined in step 504 (e.g., as the optimal position of the eyebox 120). A decision is then made as to whether adjustments are desired to be made to the position of the perceived region 300 in step 506. For example, the decision in step 506 is based on whether the perceived region 300 is within the optical path 118 of the user so that the perceived region 300 may be viewable within the eyebox 120 of the user. In the case wherein the perceived region 300 is viewable within the eyebox 120 of the user, a command is input by the user via the user input interface 126 in step 502. For example, in the case wherein the perceived region 300 is viewable within the eyebox 120 of the user, a loop may continue from step 506 to step 502 until the perceived region 300 is not viewable within the eyebox 120 of the user. For example, the loop allows for the user to adjust the user preferences via the user input interface 126. For example, the process 500 repeats to adjust the perceived region 300 until it is as a position that is ideal in consideration of the eyebox 120 of the user.

In the case wherein the perceived region 300 is not viewable within the eyebox 120 of the user, a decision (step 530) is made as to what direction (e.g., upwards or downwards) the perceived region 300 should be repositioned to, so that the perceived region 300 is viewable within the eyebox 120 of the user or more easy for the user to view. For example, in the case wherein it is determined that the perceived region 300 should be heightened or moved upward (step 508), the user input interface 126 is engaged to heighten the perceived region 300 by at least one position (i.e., 1-15). For example, the user may input a command to engage the user input interface 126. Step 512 then determines whether the at least one position the perceived region 300 is requested to be heightened to any of the foundational positions 1, 7, or 15. In the case wherein the perceived region 300 is requested to be heightened to one of the foundational positions 1, 7, or 15, the motor 110 drives the tilt of the second mirror 108, thereby adjusting the display region 130 so that the perceived region 300 is viewable within the eyebox 120 of the user (step 514). Step 516 then resets the video control timing software. It is understood that the video control timing software is reset at each foundational position 1, 7, and 15. A decision (step 518) is then made as to whether the perceived region 300 is viewable within the eyebox 120. In the case wherein the perceived region 300 is viewable within the eyebox 120, the process 500 ends. In the case wherein the perceived region 300 is not yet viewable within the eyebox 120, a loop may be created from step 518 to step 502 so another command may be input by the user via the user input interface 126 in step 502.

In the case wherein the perceived region 300 is not requested to be heightened to any of the foundational positions 1, 7, or 15, but rather one of the intermediate positions 2-6 or 8-14, the video control timing software drives an adjustment of the display region 130 so that the perceived region 300 is viewable within the eyebox 120 of the user (step 520). A decision (step 518) is then made as to whether the perceived region 300 is viewable within the eyebox 120. In the case wherein the perceived region 300 is viewable within the eyebox 120, the process 500 ends. In the case wherein the perceived region 300 is not yet viewable within the eyebox 120, a loop may be created from step 518 to step 502 so another command may be input by the user via the user input interface 126 in step 502.

As another example, in the case wherein it is determined that the height of the perceived region 300 should be reduced or moved downward (step 510), the user input interface 126 is engaged to reduce the height of the perceived region 300 by at least one step or position (e.g., 1-15). Step 522 then determines whether the at least one position the perceived region 300 is requested to be reduced to is any of the foundational positions 1, 7, or 15. In the case wherein the perceived region 300 is requested to be reduced to is any of the foundational positions 1, 7, or 15, the motor 110 drives the tilt of the second mirror 108, therein adjusting the display region 130 so that the perceived region 300 is viewable within the eyebox 120 of the user (step 524). Step 526 then resets the video control timing software. It is understood that the video control timing software is reset at each foundational position 1, 7, and 15. A decision (step 518) is then made as to whether the perceived region 300 is viewable within the eyebox 120. In the case wherein the perceived region 300 is viewable within the eyebox 120, the process 500 ends. In the case wherein the perceived region 300 is not yet viewable within the eyebox 120, a loop may be created from step 518 to step 502 so another command may be input by the user via the user input interface 126 in step 502.

In the case wherein the perceived region 300 is not requested to be reduced to any of the foundational positions 1, 7, or 15, but rather one of the intermediate positions 2-6 or 8-14, the video control timing drives an adjustment of the display region 130 so that the perceived region 300 is viewable within the eyebox 120 of the user (step 528). A decision (step 518) is then made as to whether the perceived region 300 is viewable within the eyebox 120. In the case wherein the perceived region 300 is viewable within the eyebox 120, the process 500 ends. In the case wherein the perceived region 300 is not yet viewable within the eyebox 120, a loop may be created from step 518 to step 502 so another command may be input by the user via the user input interface 126 in step 502.

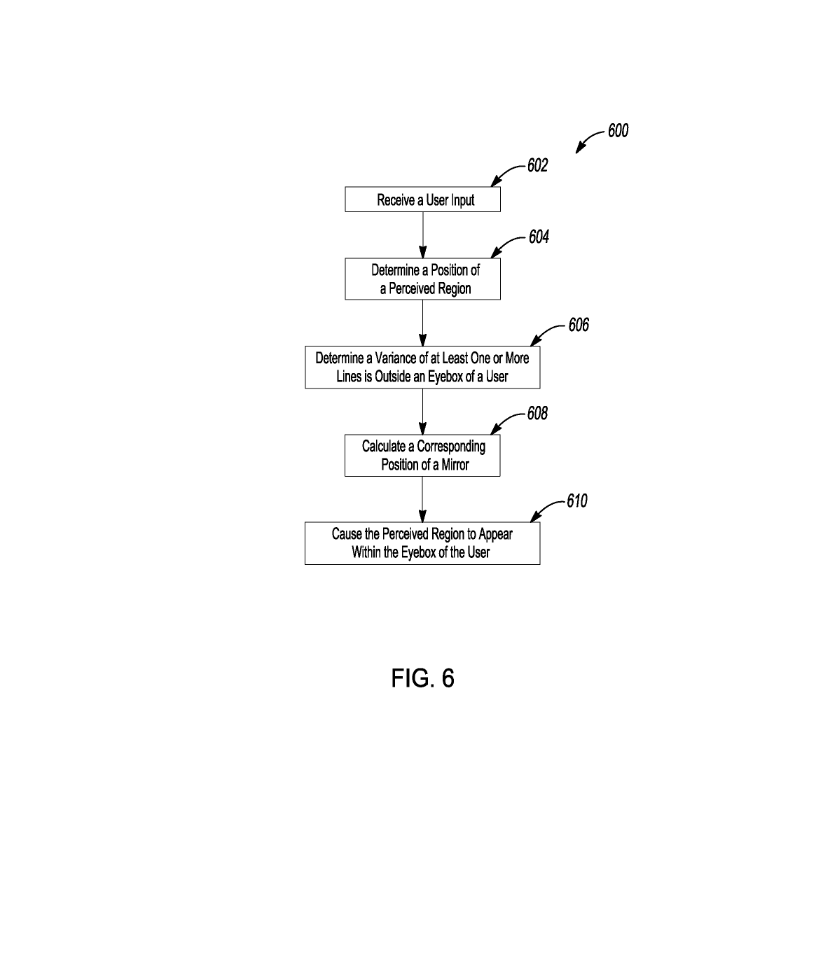

FIG. 6 is a flowchart illustrating an example method 600 for controlling the position (e.g., causing the position to change) of the projected display within the eyebox 120 of the user. At step 602, a user preference (e.g., or user information or user input) is received. For example, the user preference is received by the video display controller 102 via the user input interface 126. For example, the user input interface 126 receives user input from any suitable user input device, including but not limited to a touch screen, vehicle-mounted actuators (e.g., buttons, switches, knobs, dials, etc.), a microphone (e.g., for voice commands), an external device (e.g., a mobile device of a vehicle occupant), and/or other user input devices. For example, the user information may be a user preference such as content, height, and/or format of the displayed data.

At step 604, a determination of the position of the perceived region 300 is made. For example, the determination of the position of the perceived region 300 is based on the user preference. For example, the determination is made based on the height of the eyebox 120 of the user that is associated with the optical path 118 that originates from the eyebox 120 of the user and represents at least the portion of the viewable range of the user. The optical path 118 may vary based on the height of the eyebox 120 of the user. For example, the height of the eyebox 120 can be based on the height of the user.

At step 606, a variance of the at least one or more lines being outside the eyebox 120 of the user is determined. For example, the determination that the variance of the at least one or more lines is outside the eyebox 120 of the user is based on the position of the perceived region 300. For example, the variance of the at least one or more lines may be an offset or adjustment of one or more lines of the plurality of lines within the display region 130.

At step 608, a corresponding position of a mirror is calculated, such as the corresponding position of the second mirror 108. As another example, the calculation of the corresponding position of the second mirror 108 is based on the determined variance of the at least one or more lines being outside the eyebox of the user. For example, the motor 110 drives the tilt of the second mirror 108 so that the display region 130 is displayed to the user at any of the foundational positions 1, 7, and 15. In another example, any of the intermediate positions 2-6 and 8-14 are achieved by offsetting the position of the display region 130 from any of the foundational positions 1, 7, and 15. As described herein, any number of foundational positions and intermediate position are contemplated.

At step 610, the perceived region 300 is caused to appear within the eyebox 120 of the user. For example, the perceived region 300 is caused to appear within the eyebox 120 of the user based on the axis of tilt of the second mirror 108. As another example, the perceived region 300 is caused to appear within the eyebox 120 of the user based on the variance of the at least one or more lines. As a further example, the perceived region 300 is caused to appear within the eyebox 120 of the user based on the combination of the axis of tilt of the second mirror 108 and the variance of the at least one or more lines. For example, causing the perceived region 300 to appear within the eyebox 120 of the user comprises adjusting the corresponding position of the second mirror 108 using the motor 110. As another example, causing the perceived region 300 to appear within the eyebox 120 of the user comprises adjusting the perceived region 300 within a display region 130 using a video timing control.

Based on the foregoing, the following provides a general overview of the present disclosure and is not a comprehensive summary. In a first embodiment A1, a method comprising receiving, by a video display controller, a user input; determining, based on the user input, a position of a perceived region; determining, based on the position of the perceived region, a variance of at least one or more lines is outside an eyebox of a user; calculating, based on the variance of the least one or more lines being outside the eyebox of the user, a corresponding position of a mirror; and causing, based on the corresponding position of the mirror and the determined variance of the at least one or more lines, the perceived region to appear within the eyebox of the user.

In a second embodiment A2, which may include the first embodiment A1, the user input comprises at least one of: a content of the perceived region, a height of the perceived region, or a format of the perceived region. In a third embodiment A3, which may include any combination of the first through second embodiments A1-A2, a display region includes the perceived region, wherein the perceived region is varied based on a video control timer. In a fourth embodiment A4, which may include any combination of the first through third embodiments A1-A3, causing the perceived region to appear within the eyebox of the user comprises adjusting the corresponding position of the mirror using a motor and adjusting the perceived region within the display region using a video timing control.

In a fifth embodiment A5, which may include any combination of the first through fourth embodiments A1-A4, wherein causing the perceived region to appear within the eyebox of the user comprises controlling a motor to drive a tilt of the mirror to thereby change a tilt position of the mirror. In a sixth embodiment A6, which may include any combination of the first through fifth embodiments A1-A5, wherein the tilt of the mirror is based on at least one preset positional interval corresponding to a foundational position. In a seventh embodiment A7, which may include any combination of the first through sixth embodiments A1-A6, wherein the position of the perceived region is adjusted based on the eyebox of the user.

In an eighth embodiment A8, which may include any combination of the first through seventh embodiments A1-A7, an apparatus, comprising a display; a first mirror; a second mirror; a motor; and a video display controller, wherein the video controller is configured to receive a user input; determine, based on the user preference, a position of a perceived region; determine, based on the position of the perceived region, a variance of at least one or more lines is outside an eyebox of a user; calculate, based on the variance of the least one or more lines being outside the eyebox of the user, an axis of tilt of the mirror; and cause, based on the corresponding position of the mirror and the determined variance of the at least one or more lines, the perceived region to appear within the eyebox of the user.

In a ninth embodiment A9, which may include any combination of the first through eighth embodiments A1-A8, wherein the user preference comprises at least one of: a content of the perceived region, a height of the perceived region, or a format of the perceived region. in a tenth embodiment A10, which may include any combination of the first through ninth embodiments A1-A9, wherein a display region includes the perceived region, wherein the perceived region is varied based on a video control timer. In an eleventh embodiment A11, which may include any combination of the first through tenth embodiments A1-A10, wherein causing the perceived region to appear within the eyebox of the user comprises adjusting the corresponding position of the mirror using a motor and adjusting the perceived region within the display region using a video timing control. in a twelfth embodiment A12, which may include any combination of the first through eleventh embodiments A1-A11, wherein the video display controller is further configured to cause the perceived region to appear within the eyebox of the user comprises controlling a motor to drive a tilt of the mirror to thereby change a tilt position of the mirror.

In a thirteenth embodiment A13, which may include any combination of the first through twelfth embodiments A1-A12, wherein the tilt of the mirror is based on at least one preset positional interval corresponding to a foundational position. In a fourteenth embodiment A14, which may include any combination of the first through thirteenth embodiments A1-A13, wherein the position of the perceived region is adjusted based on the eyebox of the user.

In a fifteenth embodiment A15, which may include any combination of the first through fourteenth embodiments A1-A14, one or more non-transitory computer- readable media storing processor-executable instructions that, when executed by at least one processor, cause the at least one processor to receive a user input; determine, based on the user preference, a position of a perceived region; determine, based on the position of the perceived region, a variance of at least one or more lines is outside an eyebox of a user; calculate, based on the variance of the least one or more lines being outside the eyebox of the user, an axis of tilt of the mirror; and cause, based on the corresponding position of the mirror and the determined variance of the at least one or more lines, the perceived region to appear within the eyebox of the user.

In a sixteenth embodiment A16, which may include any combination of the first through fifthteen embodiments A1-A15, wherein the user preference comprises at least one of: a content of the perceived region, a height of the perceived region, or a format of the perceived region. In a seventeenth embodiment A17, which may include any combination of the first through sixteenth embodiments A1-A16, wherein a display region includes the perceived region, wherein the perceived region is varied based on a video control timer. In an eighteenth embodiment A18, which may include any combination of the first through seventeenth embodiments A1-A17, wherein causing the perceived region to appear within the eyebox of the user comprises controlling a motor to drive a tilt of the mirror to thereby change a tilt position of the mirror. In a nineteenth embodiment A19, which may include any combination of the first through eighteenth embodiments A1-A18, wherein the tilt of the mirror is based on at least one preset positional interval corresponding to a foundational position. In a twentieth embodiment A20, which may include any combination of the first through nineteenth embodiments A1-A19, wherein the position of the perceived region is adjusted based on the eyebox of the user.

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method, comprising:
receiving, by a video display controller, a user input;
determining, based on the user input, a position of a perceived region;
determining, based on the position of the perceived region, a variance of at least one or more lines is outside an eyebox of a user;
calculating, based on the variance of the least one or more lines being outside the eyebox of the user, a corresponding position of a mirror; and
causing, based on the corresponding position of the mirror and the determined variance of the at least one or more lines, the perceived region to appear within the eyebox of the user.

2. The method of claim 1, wherein the user input comprises at least one of: a content of the perceived region, a height of the perceived region, or a format of the perceived region.

3. The method of claim 1, wherein a display region includes the perceived region, wherein the perceived region is varied based on a video control timer.

4. The method of claim 3, wherein causing the perceived region to appear within the eyebox of the user comprises:
adjusting the corresponding position of the mirror using a motor; and
adjusting the perceived region within the display region using a video timing control.

5. The method of claim 1, wherein causing the perceived region to appear within the eyebox of the user comprises controlling a motor to drive a tilt of the mirror to thereby change a tilt position of the mirror.

6. The method of claim 5, wherein the tilt of the mirror is based on at least one preset positional interval corresponding to a foundational position.

7. The method of claim 1, wherein the position of the perceived region is adjusted based on the eyebox of the user.

8. An apparatus, comprising:
a display;
a first mirror;
a second mirror;
a motor; and
a video display controller, wherein the video display controller is configured to:
receive a user input;
determine, based on the user input, a position of a perceived region;
determine, based on the position of the perceived region, a variance of at least one or more lines is outside an eyebox of a user;
calculate, based on the variance of the least one or more lines being outside the eyebox of the user, an axis of tilt of the second mirror; and
cause, based on the corresponding position of the second mirror and the determined variance of the at least one or more lines, the perceived region to appear within the eyebox of the user.

9. The apparatus of claim 8, wherein the user input comprises at least one of: a content of the perceived region, a height of the perceived region, or a format of the perceived region.

10. The apparatus of claim 8, wherein a display region includes the perceived region, wherein the perceived region is varied based on a video control timer.

11. The apparatus of claim 10, wherein causing the perceived region to appear within the eyebox of the user comprises:
adjusting the corresponding position of the second mirror using the motor; and
adjusting the perceived region within the display region using a video timing control.

12. The apparatus of claim 8, wherein the video display controller is further configured to cause the perceived region to appear within the eyebox of the user comprises controlling the motor to drive a tilt of the second mirror to thereby change a tilt position of the second mirror.

13. The apparatus of claim 12, wherein the tilt of the second mirror is based on at least one preset positional interval corresponding to a foundational position.

14. The apparatus of claim 8, wherein the position of the perceived region is adjusted based on the eyebox of the user.

15. One or more non-transitory computer-readable media storing processor-executable instructions that, when executed by at least one processor, cause the at least one processor to:
receive a user input;
determine, based on the user input, a position of a perceived region;
determine, based on the position of the perceived region, a variance of at least one or more lines is outside an eyebox of a user;
calculate, based on the variance of the least one or more lines being outside the eyebox of the user, an axis of tilt of a mirror; and
cause, based on the corresponding position of the mirror and the determined variance of the at least one or more lines, the perceived region to appear within the eyebox of the user.

16. The one or more non-transitory computer-readable media of claim 15, wherein the user input comprises at least one of: a content of the perceived region, a height of the perceived region, or a format of the perceived region.

17. The one or more non-transitory computer-readable media of claim 15, wherein a display region includes the perceived region, wherein the perceived region is varied based on a video control timer.

18. The one or more non-transitory computer-readable media of claim 15, wherein causing the perceived region to appear within the eyebox of the user comprises controlling a motor to drive a tilt of the mirror to thereby change a tilt position of the mirror.

19. The one or more non-transitory computer-readable media of claim 18, wherein the tilt of the mirror is based on at least one preset positional interval corresponding to a foundational position.

20. The one or more non-transitory computer-readable media of claim 15, wherein the position of the perceived region is adjusted based on the eyebox of the user.
